(19) United States
(12) Patent Application Publication
(10) Pub. No.: US 2009/0294042 A1
(43) Pub. Date: Dec. 3, 2009

(54) CUTTING METHOD AND CUTTING APPARATUS

(75) Inventors: Shinsuke TAKAHASHI, Minami-Ashigara-shi (JP); Kyoushisa Uchiumi, Minami-Ashigara-shi (JP); Tatsuya Fujinami, Odawara-shi (JP)

Correspondence Address: YOUNG & THOMPSON, 209 Madison Street, Suite 500, ALEXANDRIA, VA, 22314, US

(73) Assignee: FUJIFILM CORPORATION, TOKYO (JP)

(21) Appl. No.: 12/474,286

(22) Filed: May 29, 2009

(30) Foreign Application Priority Data
Jun. 2, 2008 (JP) 2008-144700

(51) Int. Cl. B32B 38/10

(52) U.S. Cl. 156/248; 156/510

(57) ABSTRACT

A cutting method and a cutting apparatus are provided which are capable of cutting a film without causing the cracking of a hard thin film or the deformation and/or property change of the layer beneath the hard thin film. The cutting apparatus includes: a conveying device that conveys a layered film including a base material and an inorganic film being a surface layer harder than the base material; a laminating section that attaches a laminate film to a predetermined cutting position of the inorganic film of the traveling layered film; a cutting section that cuts the layered film to which the laminate film is attached along the predetermined cutting position from the side opposite to the laminate film together with the laminate film; and a detaching section that detaches the laminate film after the cutting from the layered film.

### BACKGROUND OF THE INVENTION

1. Field of the Invention

The present invention relates to a cutting method and a cutting apparatus, in particular, to a cutting method and a cutting apparatus for cutting lengthwise a lengthy film in a production process of a functional film (functional sheet).

2. Description of the Related Art

In various devices such as optical elements, display devices such as liquid crystal displays and organic EL displays, semiconductor devices and thin film solar cells, there are used gas-barrier films, protective films, and optical films such as optical filters and antireflection films as functional films (functional sheets). Known as an example of such functional films is a functional film (layered film) in which an organic film including a polymer as the main component thereof is formed on a base material formed of a plastic film or the like, and an inorganic film composed of an inorganic material is formed as a hard thin film on the organic film by a vacuum film formation method.

A film production apparatus for producing a functional film or the like conducts a cutting step in which a lengthy film is cut lengthwise in accordance with the product width. In general, such a cutting step is conducted by making the lengthy film pass through between a rotary lower blade and a rotary upper blade.

When a film having such a hard thin film as the above-described inorganic film is cut in such a cutting step, the hard thin film may be cracked. In the case where the hard thin film is cracked, the quality of the product may be degraded, or there may occur a trouble such that the cracked fragments are attached again to the film surface.

Accordingly, there have been proposed various methods for preventing the cracking of the hard thin film at the time of the cutting step. Japanese Patent Application Laid-Open No. 61-180932, for example, describes a method in which only a hard magnetic layer on a base material is cut with a laser and then the base material is cut with a cutter. According to this method, the cutting is conducted after the magnetic layer has been evaporated with a laser, and hence the cracking generation in the magnetic layer can be prevented.

Additionally, Japanese National Publication of International Patent Application No. 2002-512133 describes a method in which a decorative layer on a support is removed with a laser radiation, and then the support is detached with a blade along the trace of the removal. According to this method, when the support is detached with a blade, the decorative layer has already been removed, and hence the generation of a plenty of dust or powder due to the decorative layer can be prevented.

### SUMMARY OF THE INVENTION

However, Japanese Patent Application Laid-Open No. 61-180932 and Japanese National Publication of International Patent Application No. 2002-512133 offer a problem such that when a laser is irradiated to the hard thin film, the layer beneath the hard thin film is heated to consequently undergo the deformation and/or property change thereof. In particular, when an organic layer is provided as the layer beneath the hard thin film, the laser is irradiated to the organic layer and consequently the organic layer undergoes the deformation and/or property change thereof.

The present invention has been achieved under the above-described circumstances, and aims to provide a cutting method and a cutting apparatus which are capable of cutting a film without causing the cracking of a hard thin film or the deformation and/or property change of the layer beneath the hard thin film.

For the purpose of achieving the above-described object, a first aspect of the present invention provides a cutting method including: a laminating step of attaching a laminate film to a hard thin film of a layered body including a support and the hard thin film being a surface layer harder than the support; a cutting step of cutting the layered body to which the laminate film is attached from the side opposite to the laminate film together with the laminate film; and a detaching step of detaching the laminate film after the cutting from the hard thin film.

The inventors of the present invention have obtained a finding that the factor causing the cracking of the hard thin film in the cutting step is ascribable to the fact that the support is largely deformed at the time of cutting and the hard thin film cannot follow such deformation of the support. Further, the inventors of the present invention have obtained another finding that the cracking of the hard thin film can be prevented by attaching a laminate film to the hard thin film prior to cutting and by thereafter conducting the cutting from the side opposite to the laminate film together with the laminate film because thus the cutting is conducted in such a way that the laminate film but not the support is deformed.

The present invention has been achieved on the basis of such findings; accordingly, a laminate film is attached to the layered body prior to the cutting from the side of the hard thin film and thereafter the layered body is cut from the side opposite to the laminate film, and thus the present invention can prevent the cracking of the hard thin film at the time of the cutting step.

According to a second aspect of the present invention, in the cutting method according to the first aspect, the laminating step, the cutting step and the detaching step are continuously performed while the layered body formed in a lengthy shape is being made to travel.

In the cutting method according to the second aspect, the laminating step, the cutting step and the detaching step are continuously performed, and hence the cutting apparatus employing the cutting method can be reduced in size.

According to a third aspect of the present invention, in the cutting method according to the first or second aspect, in the cutting step, the layered body is cut at a plurality of positions thereof, and in the laminating step, the laminate film is attached to each of the plurality of cutting positions, along each of the cutting positions.

In the cutting method according to the third aspect, the laminate film is attached to each of the cutting positions, and hence the amount of the laminate film used can be reduced.

According to a fourth aspect of the present invention, in the cutting method according to any one of the first to third aspects, the layered body comprises a buffer layer softer than the hard thin film between the hard thin film and the support.

The layered body having the support, the buffer layer and the hard thin film undergoes the deformation and/or property change of the buffer layer when a laser is applied as a partial cutting step; however, in the cutting method according to any one of the aspects of the present invention, the cutting is conducted simply by attaching the laminate film, and hence the deformation and/or property change of the buffer layer can be prevented particularly effectively.

According to a fifth aspect of the present invention, in the cutting method according to any one of the first to fourth aspects, the hard thin film has a hardness of HRC 70 or more. The hard thin film having a hardness of HRC 70 or more offers a problem that the cracking occurs very readily; however, the application of the cutting method according to any one of the aspects of the present invention enables to prevent the cracking of the hard thin film particularly effectively.

For the purpose of achieving the above-described object, a sixth aspect of the present invention provides a cutting apparatus including: a conveying device that conveys, in a lengthwise direction, a lengthy layered body including a support and a hard thin film being a surface layer harder than the support; a laminating device that attaches a laminate film to a predetermined cutting position of the hard thin film of the traveling layered body conveyed by the conveying device; a cutting device that cuts the layered body to which the laminate film is attached along the predetermined cutting position from the side opposite to the laminate film together with the laminate film; and a detaching device that detaches the laminate film after the cutting by the cutting device from the layered body.

According to the sixth aspect of the present invention, the cracking of the hard thin film at the time of the cutting step can be prevented because a laminate film is attached to the hard thin film of the layered body by the laminating device, thereafter the layered body is cut by the cutting device from the side opposite to the laminate film together with the laminate film, and the laminate film after the cutting is detached by the detaching device.

According to any one of the aspects of the present invention, a layered body free from the cracking of the hard thin film can be obtained because a laminate film is attached to the hard thin film of the layered body, thereafter the layered body is cut from the side opposite to the laminate film together with the laminate film, and the laminate film having been cut is detached from the layered body.

### BRIEF DESCRIPTION OF THE DRAWINGS

FIG. 1 is a schematic view illustrating a layered film suitable for the cutting according to the present invention;

FIG. 2 is a side view schematically illustrating the configuration of the cutting apparatus according to a first embodiment;

FIG. 3 is an oblique perspective view schematically illustrating the configuration of the cutting apparatus of FIG. 2;

FIG. 4 is a front elevation view illustrating the structure of the cutting section in the first embodiment;

FIG. 5 is an oblique perspective view schematically illustrating the configuration of the cutting apparatus according to a second embodiment;

FIG. 6 is a front elevation view illustrating the structure of the cutting section in the second embodiment;

FIG. 7 is a front elevation view illustrating a cutting section different in structure from that in FIG. 6;

FIG. 8 is a front elevation view illustrating another cutting section different in structure from that in FIG. 6; and

FIG. 9 is a table showing the results of Examples.

### DETAILED DESCRIPTION OF THE PREFERRED EMBODIMENTS

Hereinafter, the preferred embodiments of the cutting method and the cutting apparatus according to the present invention are described with reference to the accompanying drawings. First, described is a layered body (layered film) suitable for cutting with the cutting method and the cutting apparatus according to the present invention.

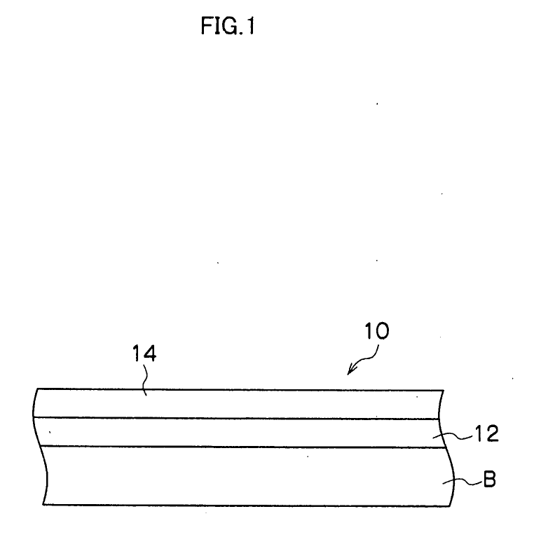

FIG. 1 is a schematic view of a layered film. In the layered film 10 illustrated in FIG. 1, an organic film 12 mainly composed of a predetermined polymer is formed on the surface of a base material B (film web) (support), and additionally an inorganic film 14 is formed on the organic film 12 by a vacuum film formation method.

The type of the base material B is not particularly limited; various base materials (base films) used for various functional films such as gas-barrier films, optical films and protective films are all usable as the base material B as long as such base materials permit the formation of the organic film 12 and the formation of the inorganic film 14 by a vacuum film formation, wherein specific examples of such base materials include various resin films such as a PET film and various metal sheets such as an aluminum sheet. Alternatively, the base material B may be a base material including various films such as a protective film and an adhesive film as formed on the surface of the base material.

The organic film 12 is a film including as the main component thereof a radiation-curable monomer or oligomer. Specifically, preferable as the monomer or oligomer used is a monomer or oligomer that has two or more ethylenically unsaturated double bonds and undergoes addition polymerization by light irradiation. Examples of such a monomer or oligomer may include a compound that has at least one ethylenically unsaturated group, in the molecule thereof, capable of undergoing addition polymerization and has a boiling point of 100° C. or higher at normal pressure. Examples of such a compound may include: monofunctional acrylates and monofunctional methacrylates such as polyethylene glycol mono(meth)acrylate, polypropylene glycol mono(meth)acrylate and phenoxyethyl(meth)acrylate; and multifunctional acrylates and multifunctional methacrylates including the following two groups: one group including polyethylene glycol di(meth)acrylate, polypropylene glycol di(meth)acrylate, trimethylolethane triacrylate, trimethylolpropane tri(meth)acrylate, trimethylolpropane diacrylate, neopentyl glycol di(meth)acrylate, pentaerythritol tetra(meth)acrylate, pentaerythritol tri(meth)acrylate, dipentaerythritol hexa(meth)acrylate, dipentaerythritol penta(meth)acrylate, hexanediol di(meth)acrylate, trimethylolpropane tri(acryloyloxypropyl)ether, tri(acryloyloxyethyl)isocyanurate, tri(acryloyloxyethyl)cyanurate, and glycerin tri(meth)acrylate; and the other group including compounds obtained by adding ethylene oxide or propylene oxide to multifunctional alcohols such as trimethylolpropane or glycerin and by thereafter (meth)acrylating the thus obtained adducts.

Further, examples of such a monomer or oligomer may also include multifunctional acrylates and methacrylates such as urethane acrylates described in Japanese Examined Application Publication Nos. 48-41708 and 50-6034 and Japanese Patent Application Laid-Open No. 51-37193, polyester acrylates described in Japanese Patent Laid-Open No. 48-64183 and Japanese Examined Application Publication Nos. 49-43191 and 52-30490, and epoxy acrylates which are reaction products between epoxy resins and (meth)acrylic acid.

Preferable among these are trimethylolpropane tri(meth)acrylate, pentaerythritol tetra(meth)acrylate, dipentaerythritol hexa(meth)acrylate and dipentaerythritol penta(meth)acrylate. Additionally, the “polymerizable compound B” described in Japanese Patent Application Laid-Open No. 11-133600 may also be quoted as a preferable compound.

Examples of the photopolymerization initiator used or the photopolymerization initiator system used may include: the vicinal polyketal donyl compound disclosed in U.S. Pat. No. 2,367,660, the acyloin ether compound described in U.S. Pat. No. 2,448,828, the aromatic acyloin compound substituted with an α-hydrocarbon described in U.S. Pat. No. 2,722,512, the polynuclear quinone compounds described in U.S. Pat. Nos. 3,046,127 and 2,951,758, the combination of a triarylimidazole dimer and a p-aminoketone described in U.S. Pat. No. 3,549,367, a benzothiazole compound and a trihalomethyl-s-triazine compound described in Japanese Examined Application Publication No. 51-48516, a trihalomethyl-triazine compound described in U.S. Pat. No. 4,239,850 and a trihalomethyloxadiazole compound described in U.S. Pat. No. 4,212,976. Particularly preferable are trihalomethyl-s-triazine, trihalomethyloxadiazole and the triarylimidazole dimer.

Additionally, the “polymerization initiator C” described in Japanese Patent Application Laid-Open No. 11-133600 may also be quoted as a preferable example. The amount of the photopolymerization initiator used is preferably 0.01 to 20% by mass and more preferably 0.5 to 10% by mass in relation to the solid content of a coating liquid. In the light irradiation for the polymerization of a liquid-crystalline compound, ultraviolet rays are preferably used. The irradiation energy is preferably 20 mJ/cm² to 50 J/cm² and more preferably 100 to 2000 mJ/cm². For the purpose of promoting the photopolymerization, light irradiation may be conducted under heating conditions.

Examples of the film formation method for the organic film 12 may include a common solution coating method and a vacuum film formation method. Coating can be made by using, as the solution coating method, a dip coating method, an air knife coating method, a curtain coating method, a roller coating method, a wire bar coating method, a gravure coating method, a slide coating method, and an extrusion coating method, using a hopper, described in U.S. Pat. No. 2,681,294. After coating, preferably, the coating liquid is dried with a heater, hot air or the like, then subjected to UV (ultraviolet ray) irradiation, and thus the radiation curable monomer or oligomer is polymerized.

It is to be noted that acrylate and methacrylate undergo polymerization inhibition due to oxygen in the air. Accordingly, when acrylate or methacrylate is used in the present invention for the organic film 12, it is preferable to lower the oxygen concentration or the oxygen partial pressure at the time of polymerization. When the oxygen concentration at the time of polymerization is lowered by a nitrogen replacement method, the oxygen concentration is preferably 2% or less and more preferably 0.5% or less. When the oxygen partial pressure at the time of polymerization is lowered by a pressure reduction method, the total pressure is preferably 1000 Pa or less and more preferably 100 Pa or less. Additionally, it is particularly preferable to conduct the ultraviolet polymerization under a reduced pressure condition of 100 Pa or less, with irradiation of an energy of 2 J/cm² or more.

In the present invention, the polymerization proportion of the monomer is preferably 80% or more, more preferably 85% or more and furthermore preferably 90% or more. The polymerization proportion as referred to herein means the proportion of the reacted polymerizable groups in all the polymerizable groups (such as the acryloyl groups or the methacryloyl groups in the case of acrylate or methacrylate) in the monomer mixture.

Additionally, preferably the organic film 12 is flat and smooth and high in the film hardness. The smoothness of the organic film 12 is 10 nm or less and more preferably 2 nm or less in terms of the average roughness (Ra value) of a 10-μm square area.

Further, the film hardness of the organic film 12 preferably has a hardness of a certain level or higher. The preferable hardness is 100 N/mm² or more and more preferably 200 N/mm² or more in terms of the indentation hardness as measured with a nano-indentation method. Alternatively, the organic film 12 preferably has a hardness of HB or higher and more preferably a hardness of H or higher in terms of the pencil hardness.

The type of the inorganic film 14 is not particularly limited, and various inorganic materials can be used for the inorganic film 14. The preparation method of the inorganic film 14 is not particularly limited; however, the inorganic film 14 is preferably formed by a vacuum film formation method, and examples of such a method include CVD (Chemical Vacuum Deposition), plasma CVD, sputtering, vacuum deposition and ion plating.

The hardness of the inorganic film 14 is preferably HRC 70 or more. The inorganic film 14 having such a hardness tends to undergo the occurrence of cracking at the time of cutting, and hence the advantageous effect of the present invention becomes remarkable. Additionally, the thickness of the inorganic film 14 is preferably 100 nm or less and particularly preferably 50 nm or less. The inorganic film 14 having such a thin thickness tends to undergo the occurrence of cracking at the time of cutting, and hence the advantageous effect of the present invention becomes remarkable.

When protective films for the various devices and apparatuses such as display devices such as organic EL displays and liquid crystal displays are produced, a silicon oxide film or the like is formed as the inorganic film 14.

When optical films such as antireflection films, light reflection films and various filters are produced, films as the inorganic film 14 are formed of materials having or developing intended optical properties.

It is to be noted that the layered body of the present invention is not limited to the layered film 10, and the base material of the layered body may be of a sheet-shaped material. The structure of the layered body is not limited to the structure formed of the three layers, namely, the base material B, the organic film 12 and the inorganic film 14, but may also be a structure formed of two layers, namely, the base material B and the inorganic film 14. Further, the structure may also be a structure which is provided, between the base material B and the inorganic film 14, with the organic film 12 composed of a plurality of layers.

In the layered film 10 formed as described above, the inorganic film 14 is formed as the hard thin film that is the hardest and thinnest and the organic film 12 is formed as the buffer layer that is softer than the inorganic film 14. When the layered film 10 thus formed is cut with a slitter, there occurs a problem that the inorganic film 14 tends to undergo cracking. For the purpose of solving this problem, it may be possible that only the inorganic film 14 of the layered film 10 is irradiated with a laser to be removed; in this case, however, there occurs a problem that the organic film 12 undergoes deformation and/or property change. The present invention provides a cutting method and a cutting apparatus to solve these problems. Hereinafter, the preferred embodiments of the cutting method and the cutting apparatus according to the present invention are described.

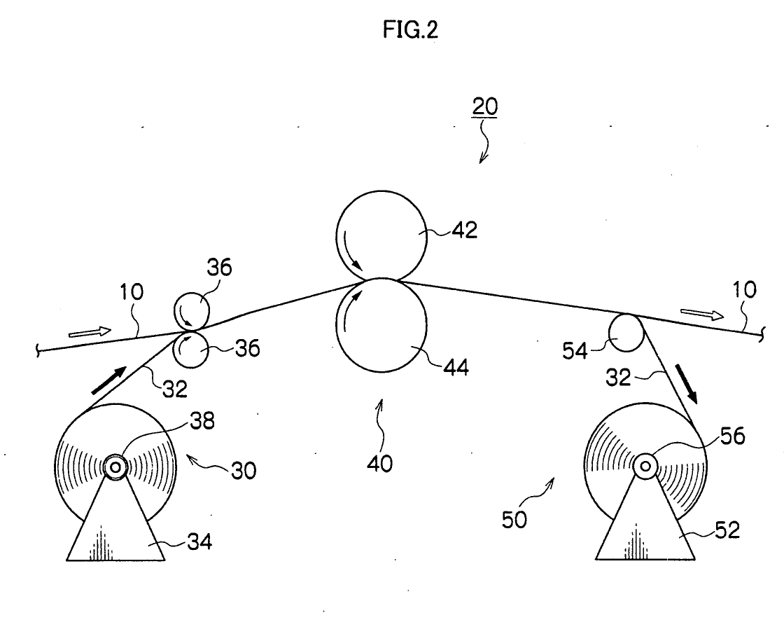

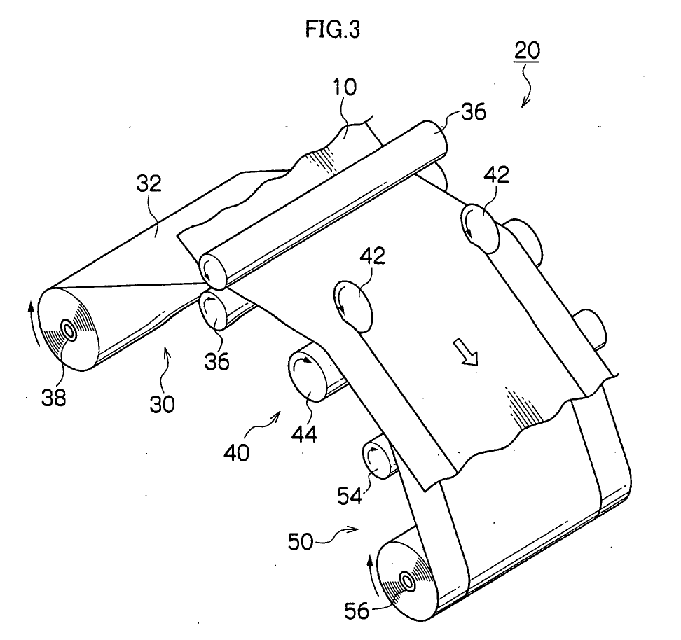

FIG. 2 is a side view schematically illustrating the configuration of the cutting apparatus 20 according to a first embodiment, and FIG. 3 is an oblique perspective view schematically illustrating the configuration of the cutting apparatus 20. The cutting apparatus 20 illustrated in these figures is an apparatus for cutting the lengthy layered film 10 in accordance with the product width and is mainly composed of a laminating section 30, a cutting section 40 and a detaching section 50. The layered film 10 is set so that the inorganic film 14 locates the lower side in FIG. 2, and the layered film 10 is conveyed (made to travel) by a conveying device (not shown) such as a feed roller in the direction indicated by the thick arrow in FIG. 2. The laminating section 30, the cutting section 40 and the detaching section 50 are disposed in this order from an upstream position in the traveling direction of the layered film 10.

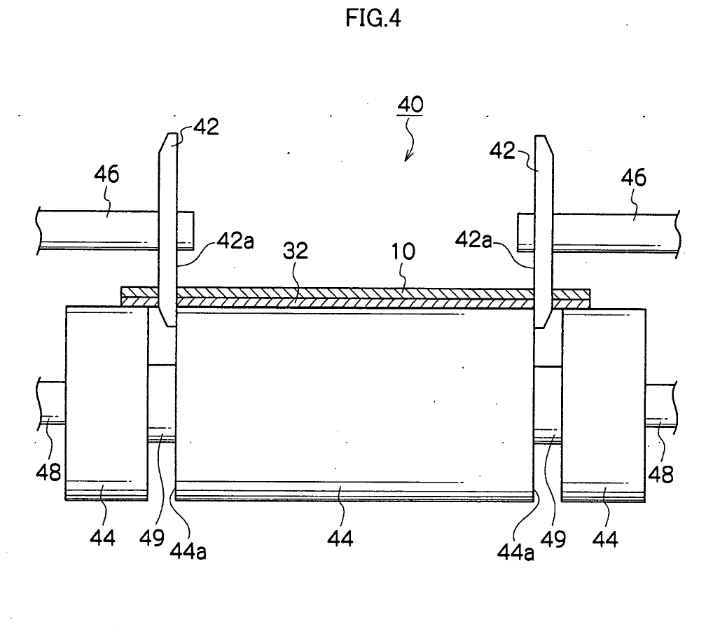

FIG. 4 is a front elevation view illustrating the cutting section 40. As shown in FIG. 4, the cutting section 40 is provided with a plurality of pairs of rotary upper blade 42 and a rotary lower blade 44, each of the pairs includes the rotary upper blade 42 and the rotary lower blade 44. As the material for the rotary upper blades 42 and the rotary lower blade 44, an SK material, a SUS material and the like are used, and tungsten carbide and the like can be also suitably used.

The rotary lower blade 44 is formed in a cylindrical shape and is supported by the main frame (not shown) of the apparatus, in a freely rotatable manner through the intermediary of a shaft 48. The rotary lower blade 44 is also connected to a motor (not shown) through the intermediary of the shaft 48, and is driven for rotation by the motor. The rotation direction and the circumferential speed of the rotary lower blade 44 are not particularly limited; however, the rotary lower blade 44 is controlled, for example, so as to rotate in the same direction as the traveling direction of the layered film 10 and at a circumferential speed equal to the traveling speed of the layered film 10.

The rotary lower blade 44 is divided into three members, namely, one central member and two end members, and a spacer 49 are provided between each of the end members and the central member of the rotary lower blade 44. Of the three members of the rotary lower blade 44, the width of the central member of the rotary lower blade 44 is designed to be equal in dimension to the product width, and the both side faces 44a of the central member are designed so as to act as circular cutting faces.

On the other hand, each of the rotary upper blades 42 is formed in a thin disc shape, and is supported by the main frame (not shown) of the apparatus, in a freely rotatable manner through the intermediary of one of shafts 46, the shafts 46 being disposed so as to be parallel with the above-described shaft 48. The shafts 46 may be designed to be dragged into rotation or to be revolutionarily driven by a motor (not shown). The rotation direction and the circumferential speed of the rotary upper blades 42 are not particularly limited; however, the rotary upper blades 42 are set, for example, so as to rotate in the same direction as the traveling direction of the layered film 10 and at a circumferential speed equal to the traveling speed of the layered film 10.

Each of the rotary upper blades 42 is disposed so as for a portion of the outer circumference edge thereof to intrude into the gap between the central member of the rotary lower blade 44 and one of the end members of the rotary lower blade 44 (in other words, so as to appear to overlap with the rotary lower blade 44 when viewed laterally). The overlap extent is set according to the thickness of the layered film 10 and the thickness of the below-described laminate film 32: the overlap extent is set so that the layered film 10 and the laminate film 32 can be cut without failure. It is to be noted that each of the rotary upper blades 42 is designed so that the side face 42a thereof facing one of the side faces 44a of the central member of the rotary lower blade 44 acts as a cutting face.

The laminating section 30 is a device that attaches the laminate film 32 to the inorganic film 14 of the layered film 10 that is traveling, and is composed of a feeding device 34 and nip rollers 36. The laminate film 32 is formed in a lengthy shape with the same width as that of the layered film 10, and an adhesive layer having a predetermined adhesive strength (for example, 0.04 to 0.20 N/25 mm) is formed on one side (the upper side or the outer side in FIG. 2) of the laminate film 32. The material for the laminate film 32 is selected from the materials that are the same in hardness as or higher in hardness than the base material B. With respect to the thickness of the laminate film 32, the materials for the laminate film 32 is selected from the materials that are the same in thickness as or larger in thickness than the base material B. The laminate film 32 is set to the feeding device 34 in a state of being wound around a winding core 38 in a roll shape, and is fed by rotating the winding core 38.

The laminate film 32 having been fed is attached to the layered film 10 with the nip rollers 36. In this attachment, the laminate film 32 is attached to the whole surface of the inorganic film 14 of the layered film 10. In the present embodiment, the laminate film 32 is attached to the layered film 10 with the nip rollers 36; however, the attachment device is not limited to the nip rollers.

The detaching section 50 is a device that detaches, after cutting, the laminate film 32 attached in the laminating section 30 from the layered film 10, the detaching section 50 including a wind-up device 52 and a detaching roller 54. The detaching roller 54 is disposed so as to be brought into contact with the laminate film 32 attached to the layered film 10, and the laminate film 32 is detached from the layered film 10 by the detaching roller 54. The laminate film 32 detached by the detaching roller 54 is wound up by the wind-up device 52. The wind-up device 52 has a wind-up shaft 56, and the laminate film 32 is wound up by rotating the wind-up shaft 56. It is to be noted that a suction device such as a suction roller may also be disposed on the side opposite to the detaching roller 54 across the layered film 10 so as to suck the layered film 10.

Next, the operation of the cutting apparatus 20 of the present embodiment is described.

First, the laminating section 30 attaches the laminate film 32 to the whole surface of the inorganic film 14 of the layered film 10. The cutting section 40 cuts the layered film 10 attached with the laminate film 32, together with the laminate film 32. In this cutting, the rotary upper blades 42 are made to penetrate into the layered film 10 from the side opposite to the laminate film 32 (namely, the base material B side) to cut the layered film 10. When the cutting is conducted in such a way, the laminate film 32 but not the base material B is deformed. In other words, if the rotary upper blades 42 are made to penetrate into the layered film 10 from the laminate film 32 side, the cutting is completed in such a way that the base material B is torn, and hence the base material B is largely deformed; however, in the present embodiment, in the case where the rotary upper blades 42 are made to penetrate into the layered film 10 from the side opposite to the laminate film 32, the cutting is completed in such a way that the laminate film 32 is torn, and hence the laminate film 32 but not the base material B is largely deformed. The laminate film 32 is only attached to the inorganic film 14, and hence, even when the laminate film 32 is largely deformed, no cracking occurs in the inorganic film 14. Consequently, the cracking of the inorganic film 14, due to the large deformation of the base material B, can be prevented.

In particular, in the present embodiment, the material for the laminate film 32 is selected from the materials that are the same in hardness as or higher in hardness than the base material B. Consequently, there can be prevented the large deformation of the base material B due to such unsuccessful support by the laminate film 32 at the time of cutting as in the case where the laminate film 32 is too soft. Additionally, in the present embodiment, the thickness of the laminate film 32 is set to be the same as or larger than the thickness of the base material B, and hence the laminate film 32 can be prevented from being torn from the inorganic film 14 at the time of cutting.

After the cutting, the layered film 10 attached with the laminate film 32 is conveyed to the detaching section 50, where the laminate film 32 is detached from the layered film 10. In this way, there can be obtained the layered film 10 free from the cracking on the inorganic film 14.

As described above, according to the present embodiment, the layered film 10 in which the laminate film 32 is attached to the inorganic film 14 is cut from the side opposite to the laminate film 32, and hence the cracking of the inorganic film 14 at the time of cutting can be prevented.

Additionally, according to the present embodiment, the cutting is conducted with the attachment of the laminate film 32, and hence the generation of the chips of the inorganic film 14 at the time of cutting can be prevented.

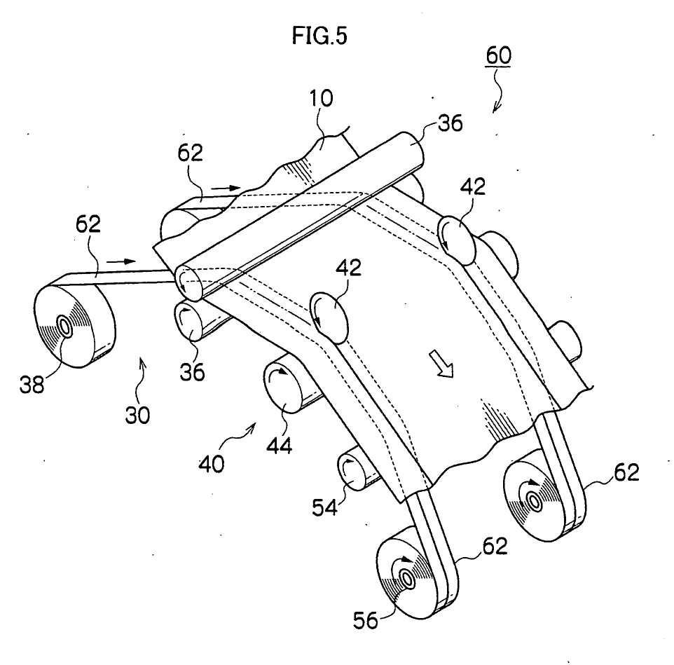

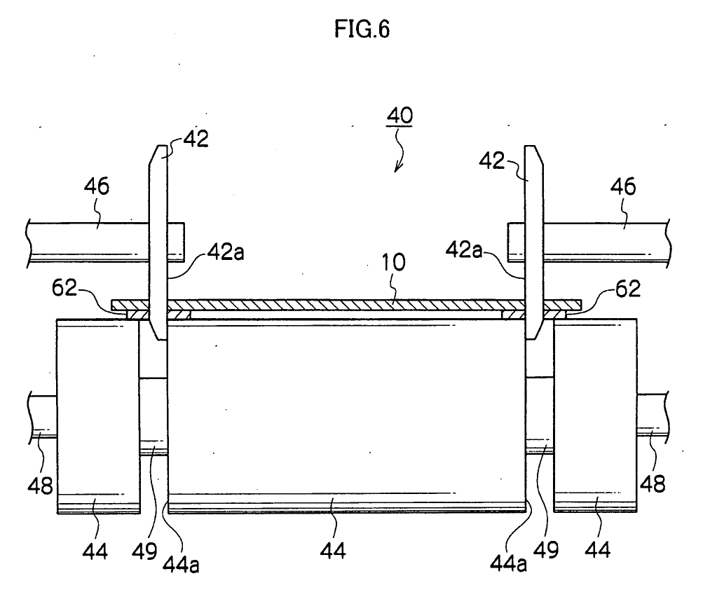

FIG. 5 is an oblique perspective view schematically illustrating the configuration of the cutting apparatus 60 according to a second embodiment, and FIG. 6 is a front elevation view illustrating the cutting section 40 in the second embodiment. The cutting apparatus 60 of the second embodiment illustrated in these figures is different in that a plurality of laminate films 62 are attached to the layered film 10, as compared to the cutting apparatus 20 of the first embodiment illustrated in FIG. 2. Each of the laminate films 62 is formed in a belt-like shape having a width smaller than the width of the layered film 10, and the laminate films 62 are attached to the inorganic film 14 (the lower side of the layered film 10 in FIG. 5) at the predetermined cutting positions indicated by the dashed-two dotted lines in FIG. 5. In the same manner as in the first embodiment, the attached laminate films 62 are cut in the cutting section 40, and thereafter detached in the detaching section 50.

Also in the case of the second embodiment configured as described above, the laminate films 62 is deformed but the base material B is not deformed at the time of cutting, and hence the cracking of the inorganic film 14 can be prevented. Additionally, according to the second embodiment, no laminate film 62 is attached to the central portion of the layered film 10, and hence there can be prevented the problems that the adhesive layer of the laminate film 62 remains.

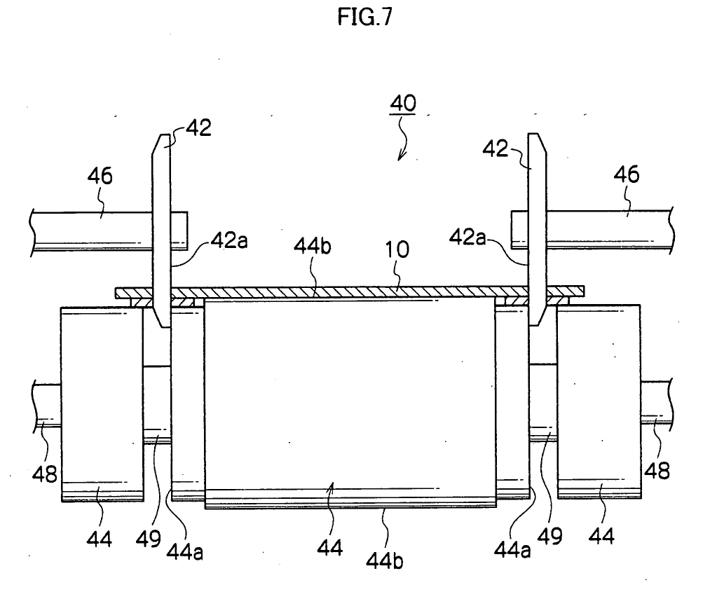

It is to be noted that, in the above-described second embodiment, at the time of cutting the widthwise central portion of the layered film 10 may be supported with the rotary lower blade 44. In other words, as shown in FIG. 7, the widthwise central portion 44b of the central member of the rotary lower blade 44 may be formed so as to take a shape which is raised over the whole circumferential surface of the widthwise central portion 44b by a height equal to the thickness of each of the laminate films 62. In this way, the widthwise central portion of the layered film 10 can be supported by the central portion 44b of the central member of the rotary lower blade 44, and hence the layered film 10 can be prevented from being deformed at the time of cutting.

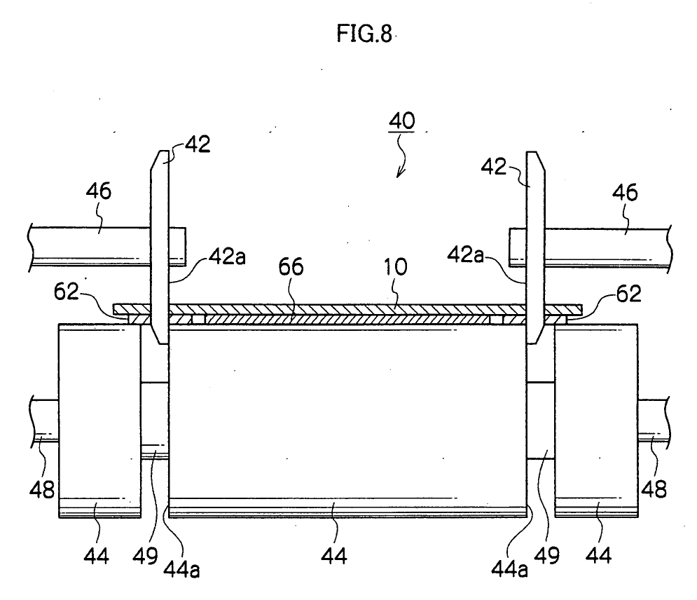

Additionally, instead of giving a raised shape to the central portion 44b of the central member of the rotary lower blade 44, a dummy film 66 may be disposed between the laminate films 62, 62 as shown in FIG. 8. The thickness of the dummy film 66 is the same as the thickness of the laminate film 62, the width of the dummy film 66 is such that the dummy film 66 fits into the space between the laminate films 62, 62 and the dummy film 66 is formed in a lengthy shape. The dummy film 66 is superposed on the inorganic film 14 side of the layered film 10 at an anterior stage of the cutting section 40 and is removed from the layered film 10 at a posterior stage of the cutting section 40. In this case, the widthwise central portion of the layered film 10 can be supported with the dummy film 66, and thus the layered film 10 is prevented from being deformed at the time of cutting.

It is to be noted that in the above-described embodiments, the layered film 10 formed of the base material B, the organic film 12 and the inorganic film 14 is cut; however, the structure of the layered film is not limited to this structure. The present invention is suitable for cutting the layered bodies each having a hard thin film such as the inorganic film 14.

Additionally, in the above-described embodiments, the cutting is conducted at the widthwise end positions of the layered film 10; however, the cutting may also be conducted at the widthwise central portion of the layered film 10.

### EXAMPLES

The cutting was conducted by using the cutting apparatus shown in FIG. 2, and by varying the conditions for the layered film (the materials, the thicknesses and the like of the support (the base material), the buffer layer (the organic film) and the hard thin film (the inorganic film)), and the conditions for the laminate film (the material, the thickness and the like). Thus, the layered films subjected to the cutting were evaluated with respect to the occurrence or nonoccurrence of the cracking of the hard thin film on the basis of the following standards.

P(poor): The cracking of the hard film is identified with the naked eye.

A(average): The cracking and the partial detachment are identified with an optical microscope (×500) but not with the naked eye.

G(good): The cracking is identified but no detachment is identified with an optical microscope (×500), although no cracking being identified with the naked eye.

E(excellent): Neither the cracking nor the detachment is identified even with an optical microscope (×500).

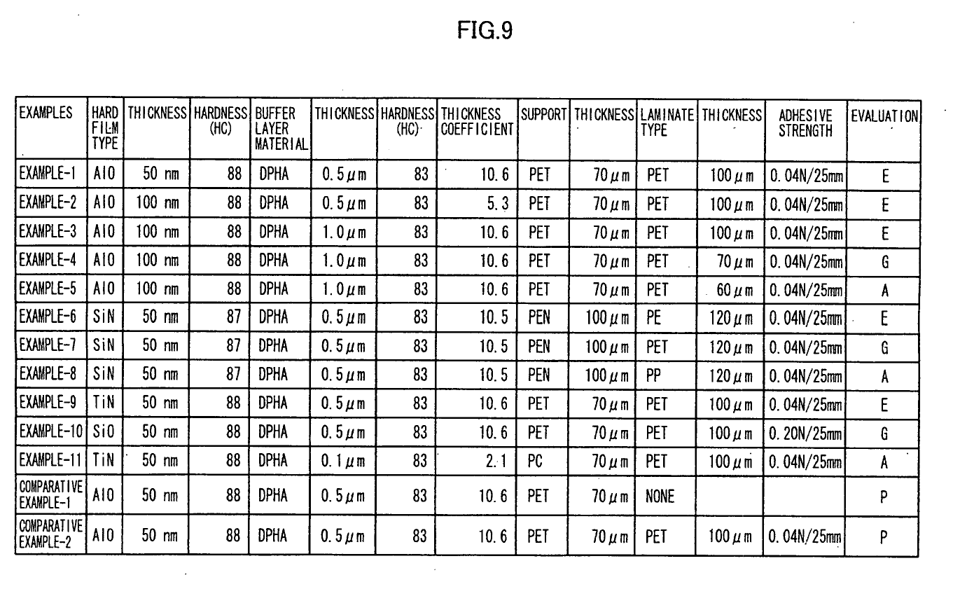

FIG. 9 shows the conditions and the evaluation results of the layered films. It is to be noted that Comparative Example 1 presents the results obtained without attachment of the laminate film, and Comparative Example 2 presents the results obtained by cutting from the laminate film side after the laminate film was attached. Additionally, in FIG. 9, PE, PP, PC, PET and DPHA stand for polyethylene, polypropylene, polycarbonate, polyethylene terephthalate and dipentaerythritol hexaacrylate, respectively.

Additionally, in FIG. 9, the adhesive strength of the laminate film was measured by a 180 degrees peeling method [25-mm width] (JIS Z-0237). The measurement conditions were as follows: 23° C.±2° C.; 50±5% RH; speed: 300 mm/min; adherend: a stainless steel plate.

Further, as the coefficient representing the relation between the thickness of the inorganic film 14, the thickness of the organic film 12, and the hardness of these films, a thickness coefficient was obtained as follows:

the thickness coefficient={(thickness of inorganic film 14)/(hardness[Hc] of inorganic film 14)}×{(hardness[Hc] of organic film 12)/(thickness of organic film 12)}.

The increase of the thickness coefficient means that the inorganic film 14 becomes harder and thinner, or the organic film 12 becomes thicker and softer; with the thickness coefficient of 2 or more, the advantageous effect of the present invention becomes remarkable.

As can be seen from FIG. 9, the cracking of the hard thin film occurred in Comparative Example 1 in which the cutting was conducted without using the laminate film and in Comparative Example 2 in which the laminate film was attached and the cutting was conducted from the laminate film side. On the contrary, the cracking of the laminate film was able to be suppressed in Examples 1 to 11 in which the laminate film was attached and the cutting was conducted from the side opposite to the laminate film. In particular, as can be seen from a comparison of Examples 1 to 4 with Example 5, preferably the thickness of the laminate film is equal to or larger than the thickness of the support. Additionally, as can be seen from a comparison of Examples 1 to 3 with Example 4, more preferably the thickness of the laminate film is larger than the thickness of the support. Moreover, as can be seen from a comparison between Examples 6 to 8, preferably the material of the laminate film is the same as the material of the support or is harder than the material of the support. Furthermore, the adhesive strength of the laminate film is preferably 0.2 N/25 mm or less and more preferably 0.04 N/25 mm or less.

What is claimed is:

1. A cutting method comprising:
a laminating step of attaching a laminate film to a hard thin film of a layered body including a support and the hard thin film being a surface layer harder than the support;
a cutting step of cutting the layered body to which the laminate film is attached from the side opposite to the laminate film together with the laminate film; and
a detaching step of detaching the laminate film after the cutting from the hard thin film.

2. The cutting method according to claim 1,
wherein, in the cutting step, the layered body is cut at a plurality of positions thereof, and
in the laminating step, the laminate film is attached to each of the plurality of cutting positions, along each of the cutting positions.

3. The cutting method according to claim 1, wherein the layered body comprises a buffer layer softer than the hard thin film between the hard thin film and the support.

4. The cutting method according to claim 1, wherein the hard thin film has a hardness of HRC 70 or more.

5. The cutting method according to claim 2, wherein the layered body comprises a buffer layer softer than the hard thin film between the hard thin film and the support.

6. The cutting method according to claim 2, wherein the hard thin film has a hardness of HRC 70 or more.

7. The cutting method according to claim 1, wherein the laminating step, the cutting step and the detaching step are continuously performed while the layered body formed in a lengthy shape is being made to travel.

8. The cutting method according to claim 7, wherein the layered body comprises a buffer layer softer than the hard thin film between the hard thin film and the support.

9. The cutting method according to claim 7, wherein the hard thin film has a hardness of HRC 70 or more.

10. The cutting method according to claim 7,
wherein, in the cutting step, the layered body is cut at a plurality of positions thereof, and
in the laminating step, the laminate film is attached to each of the plurality of cutting positions, along each of the cutting positions.

11. The cutting method according to claim 10, wherein the hard thin film has a hardness of HRC 70 or more.

12. The cutting method according to claim 10, wherein the layered body comprises a buffer layer softer than the hard thin film between the hard thin film and the support.

13. The cutting method according to claim 8, wherein the hard thin film has a hardness of HRC 70 or more.

14. A cutting apparatus comprising:
a conveying device that conveys, in a lengthwise direction, a lengthy layered body including a support and a hard thin film being a surface layer harder than the support;
a laminating device that attaches a laminate film to a predetermined cutting position of the hard thin film of the traveling layered body conveyed by the conveying device;
a cutting device that cuts the layered body to which the laminate film is attached along the predetermined cutting position from the side opposite to the laminate film together with the laminate film; and
a detaching device that detaches the laminate film after the cutting by the cutting device from the layered body.
